(19) United States
(12) Patent Application Publication
(10) Pub. No.: US 2003/0186576 A1
(43) Pub. Date: Oct. 2, 2003

(54) Electric connector structure

(76) Inventor: Chien-Chung Lin, Tao Yuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/109,701

(22) Filed: Apr. 1, 2002

(51) Int. Cl. H01R 4/50

(52) U.S. Cl. 439/342

(57) ABSTRACT

The present invention relates to an improved electric connector structure and, more particularly, to an electric connector capable of forming electric connection with circuits on a circuit board to plug with a corresponding electronic product having a plurality of pins after pin portions of terminals thereof are soldered. The present invention provides an improved electric connector structure, which comprises a plurality of terminal passageways and a plurality of terminals having elastic contact pieces. The terminal is composed of an installation portion having opposite walls and a pin portion extended below the installation portion. The two opposite walls of the installation portion are cut to form the elastic contact pieces, which are connected at one side and bent in between the two opposite walls.

### 1. FIELD OF THE INVENTION

The present invention relates to an improved electric connector structure and, more particularly, to an electric connector capable of forming electric connection with circuits on a circuit board to plug with a corresponding electronic product having a plurality of pins after pin portions of terminals thereof are soldered. The present invention is characterized in that two symmetric elastic contact pieces of the terminal used to provide elastic contact positions for a pin must be in alignment with the elastic source position. Moreover, only the upper ends of the elastic contact pieces are suspended. Because the elasticity of the elastic source position can be directly extended, bell-shaped portions of the two symmetric elastic contact pieces can have stable and uniform elasticity, and the deviation degree of the two elastic contact pieces is very small.

### 2. BACKGROUND OF THE INVENTION

When an electronic product (e.g., a central processing unit (CPU)) having a plurality of pins is to function with circuits on a circuit board, an electric connector (e.g., a CPU slot) soldered to the circuit board is generally used to let the electronic product achieve electric connection with the electric connector and the circuit board.

The above electric connector has a plurality of terminal passageways corresponding to pins of an electronic product (or pins of an electronic component) on an insulating main body thereof. A terminal is disposed in each of the terminal passageways to achieve electric contact with one of the pins.

As shown in FIG. 1, a terminal 1 of a prior art electric connector comprises a main body portion 11, a pin portion 13, and two elastic contact pieces 14. The two symmetric elastic contact pieces 14 are extended forwards from two sides of the main body portion 11 to correspondingly clamp a pin 3 of an electronic product, as shown in FIG. 2C.

As shown in FIG. 2A, in a prior art electric connector, each of the terminal passageways 2 formed in an insulating main body 200 has two symmetric wing grooves 21 corresponding to the main body portion 11. Please refer to FIG. 2B, when the terminal 1 is inserted into the terminal passageway 2, two ends of the main body portion 11 is embedded in the two wing grooves 21 to achieve positioning effect. As also shown in the figure, a pin 3 of an inserted electronic product or electronic component is already inserted into a bell-shaped guide portion (briefly termed as a bell). Please also refer to FIG. 2C, the electronic product moved is to push the pin 3 leftwards. Once the pin 3 enters the shrunk portion of the bell, the elastic contact pieces 14 will elastically contact the corresponding positions of the pin, hence letting the pin 3 achieve electric contact with the terminal 1.

However, first, the two symmetric elastic contact pieces 14 of the prior art terminal 1 used as elastic source for elastic contact with the pin 3 are multiply bent. As shown in FIG. 1, the elastic contact position for electric contact with the pin 3 is not in alignment with the elastic source position itself so that the elasticity of the elastic source position cannot be directly extended. Accordingly, the two symmetric elastic contact pieces 14 used for elastic contact with the bell portion of the pin 3 will have unstable and nonuniform elasticity.

Secondly, not only the upper end portions of the two elastic contact pieces 14 are suspended so that the elastic contact pieces 14 will be inevitably deviate, and the two elastic contact pieces 14 may have different deviation degrees because of unstable and nonuniform elasticity, not mentioning that each of the elastic contact pieces 14 has multiply bends (the bent portion from the main body portion 11 to the bell portion). When the pin 3 is pushed from the entry (rear side) of the bell to the exit (front side) of the bell, nonuniform force will be exerted between the pin 3 and the two elastic contact pieces 14. The one with higher degree of contact will be overly pressurized, while the other will be less pressurized (as shown in FIG. 2C), hence being inferior to the contact way of three points on the same plane.

Thirdly, the terminal 1 inserted into the terminal passageway 2 must be steadily positioned; otherwise, the terminal 1 may sway. Therefore, as shown in FIG. 2B, the symmetric wing grooves 21 for retaining the main body portion 11 of the terminal 1 are formed in the terminal passageway 2 to let the terminal 1 not sway and be more stable. FIG. 3 is a partly bottom view of a mold 4 used to form the terminal passageway 2 shown in FIG. 2A in an electric connector. As shown in FIG. 3, a convex portion 41 is extended from a concave portion 42 of the mold 4. In order to let the convex portion 41 form the two symmetric wing grooves 21 disclosed in FIG. 2A, the convex portion 41 must change from a rectangular body to a T-shaped body. Therefore, two symmetric processed regions 401 and 402 disclosed in FIG. 3 must be additionally removed (e.g., processing way by electric discharge). Because the two processed regions 401 and 402 are removed by electric discharge with electrodes, the processing efficiency is low, and there inevitably will be residual R angles so that the gap d between H1, H2 and H3, H4 cannot achieve the expected value of 0.10 mm. Therefore, the positioning function of the gap d to the main body portion 11 of the terminal 1 will be much impaired.

### SUMMARY OF THE INVENTION

Accordingly, the primary object of the present invention is to provide an improved electric connector structure, wherein the elastic contact positions of two elastic contact pieces of a terminal are in alignment with the elasticity source position, and only the upper ends of the elastic contact pieces are suspended. Therefore, the elasticity of the elasticity source position can be directly extended, bell portion of the two symmetric elastic contact pieces can have stable and uniform elasticity, and the deviation degree of the two elastic contact pieces is very small.

Another object of the present invention is to provide an improved electric connector structure, wherein the pin is pushed backwards (opposite to the prior art) so that contact of 2˜3 points with the pin of an electronic product can be achieved, being superior to contact of 1˜2 points with the prior art electric connector.

Yet another object of the present invention is to provide an improved electric connector structure, wherein the outside of the elastic contact piece is triply protected so that the elastic contact piece can be well protected during the manufacturing process (e.g., electroplating processing or assembly processing), thereby increasing the yield and assuring the quality.

Still yet another object of the present invention is to provide an improved electric connector structure, wherein the shape of a terminal is simplified so that the shape of a mated terminal passageway can also be simplified to be a simple rectangle. Therefore, the mold can be manufactured by means of high-accuracy, high-efficiency polishing processing. It is not necessary to use the low-efficiency electric discharge processing way. The precision of each component and the assembly quality can be enhanced.

To achieve the above objects, the present invention provides an improved electric connector structure, which comprises a plurality of terminal passageways and a plurality of terminals having elastic contact pieces. The terminal is composed of an installation portion having two opposite walls and a pin portion extended below the installation portion. The two opposite walls of the installation portion are cut to form the elastic contact pieces, which are connected at one side and bent in between the two opposite walls. Thereby, the elasticity of the elasticity source position (the connected side) can be directly extended, the bell portion of the two symmetric elastic contact pieces can have stable and uniform elasticity, and the deviation degree of the two elastic contact pieces directly formed of the walls is very small.

Also, the exit of the bell of the two symmetric elastic contact pieces exactly corresponds to a connection portion between the two opposite walls so that a pin of an electronic product can contact the two elastic contact pieces and the connection portion, thereby achieving better contact of 2˜3 points.

Moreover, the cross section of the installation portion of the terminal can be a vertically bent U shape, which is formed of two symmetric sidewalls and a rear wall. The two elastic contact pieces are formed of the two sidewalls. The outside of the elastic contact piece can thus be triply protected, hence increasing the yield and assuring the quality.

Furthermore, the shape of the terminal passageway can correspond to the profile of the above installation portion so that the terminal passageway can be simplified to be a very simple frame-shaped or rectangular terminal passageway. Therefore, the processing of mold can achieve high accuracy and high efficiency so that the precision of each component and the assembly quality can be enhanced. Additionally, the terminal is stably positioned once it is inserted into the terminal passageway. It is thus not necessary to perform additional processing to the mold (The two regions 401 and 402 must be processed in the prior art).

The various objects and advantages of the present invention will be more readily understood from the following detailed description when read in conjunction with the appended drawing, in which:

### BRIEF DESCRIPTION OF THE DRAWINGS

FIG. 1 is a perspective view of a terminal in a prior art electric connector;

FIG. 2A is a partly top view of a prior art electric connector before plugging with an electronic product, wherein a single terminal passageway in the electric connector is shown;

FIG. 2B is a partly top view of a prior art electric connector when plugging with an electronic product, wherein a pin of the electronic product is not pushed yet;

FIG. 2C is a partly top view of a prior art electric connector after plugging with an electronic product, wherein a pin of the electronic product is already pushed;

FIG. 3 is a partly bottom view of a mold used to form the terminal passageway of a prior art electric connector;

FIG. 4 is a side view showing cut lines of a terminal of the present invention;

FIG. 5 is a perspective view of a terminal of the present invention;

FIG. 6 is a front view of a terminal of the present invention;

FIG. 7A is a partly top view of an electric connector of the present invention before plugging with an electronic product, wherein a single terminal passageway in the electric connector is shown;

FIG. 7B is a partly top view of an electric connector of the present invention when plugging with an electronic product, wherein a pin of the electronic product is not pushed yet;

FIG. 7C is a partly top view of an electric connector of the present invention after plugging with an electronic product, wherein a pin of the electronic product is already pushed; and

FIG. 7D is a partly top view of an electric connector of the present invention after plugging with an electronic product, wherein a pin of the electronic product is already pushed to the end.

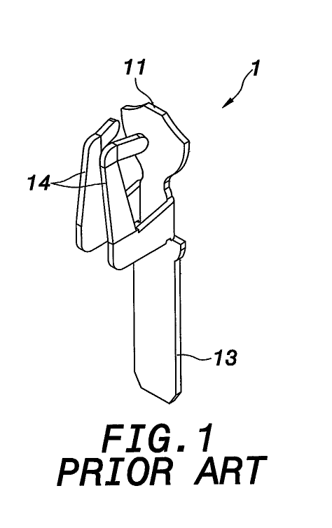

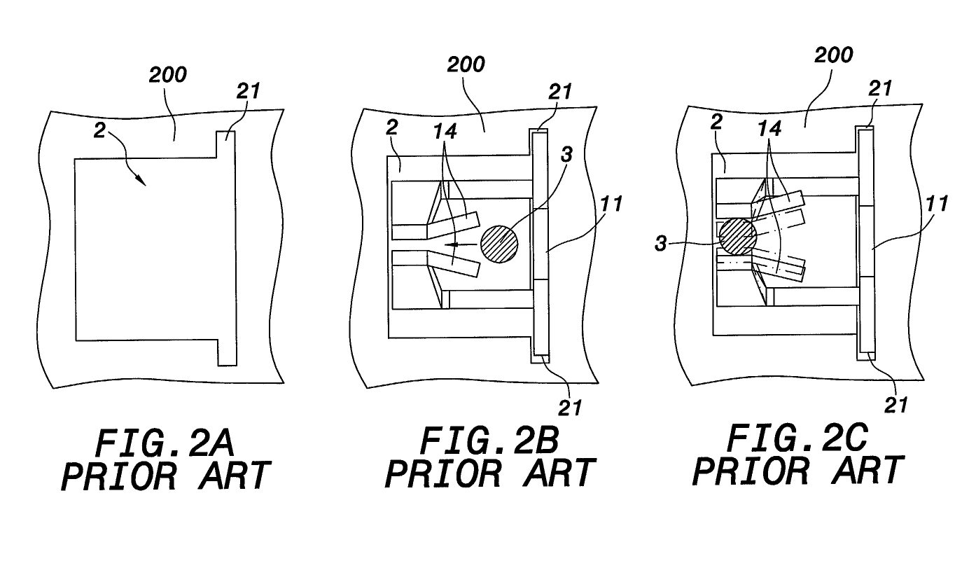

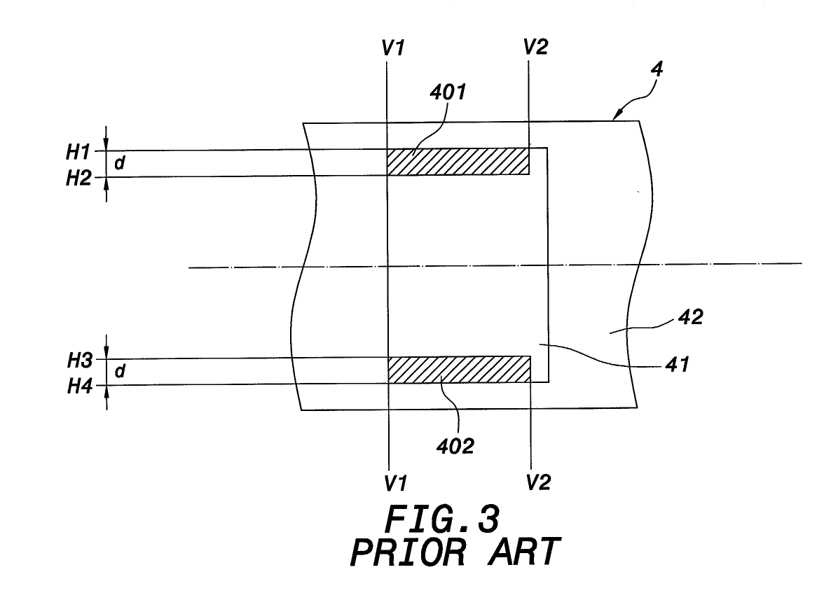

### DETAILED DESCRIPTION OF THE PREFERRED EMBODIMENTS

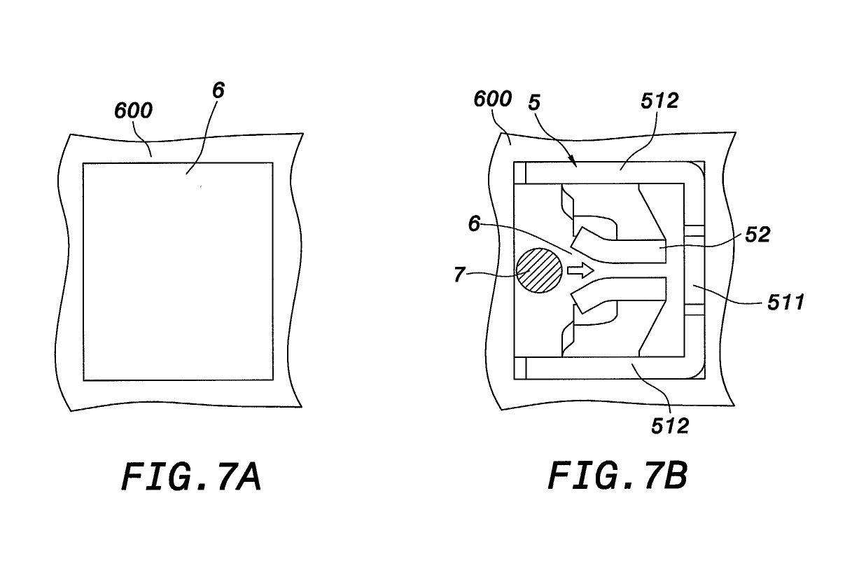

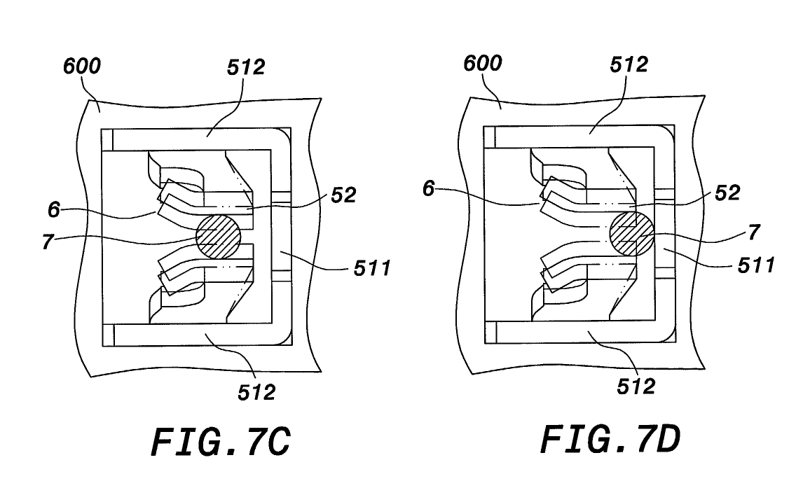

FIG. 7B shows a top view of a single terminal passageway 6, a terminal 5 therein, and a pin 7 of an electronic component or electronic product. The present invention provides an improved electric connector structure, which comprises a plurality of terminal passageways 6 and a plurality of terminals 5 having elastic contact pieces 52.

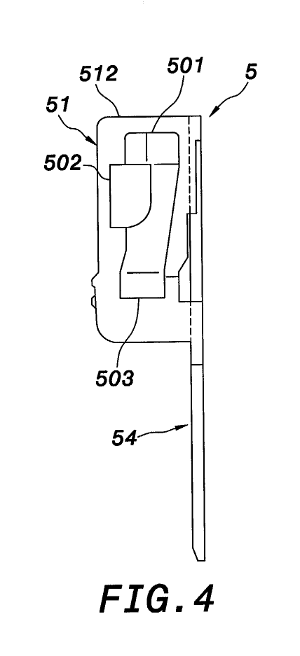

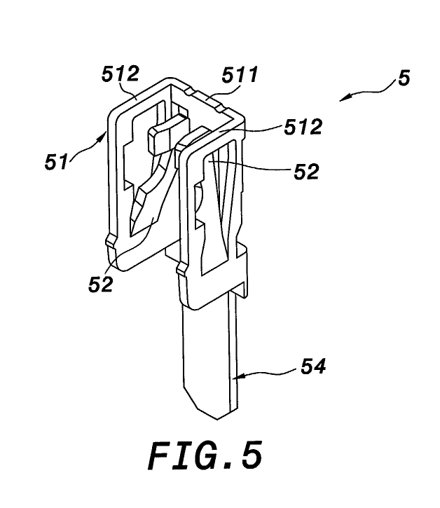

As shown in FIGS. 4 and 5, the terminal 5 is composed of an installation portion 51 and a pin portion 54. The installation portion 51 has two symmetric sidewalls 512, and a rear wall 511 at the rear side between the two symmetric sidewalls 512. The installation portion 51 has only a transversal front opening. The cross section of the whole installation portion 51 is a vertically bent U shape, as shown in FIG. 7B. The installation portion 51 of the present invention is not limited to the vertically bent U shape. The totally closed rear wall 511 is modified to diverse forms. For examples, the rear wall 551 needs only to be a crossbeam-type connection portion capable of connecting the two sidewalls 512. The connection portion can further be a shape (not shown) capable of contacting the pin. The pin 54 for soldering is extended downwards from the bottom side of the rear wall 511 of the installation portion 51.

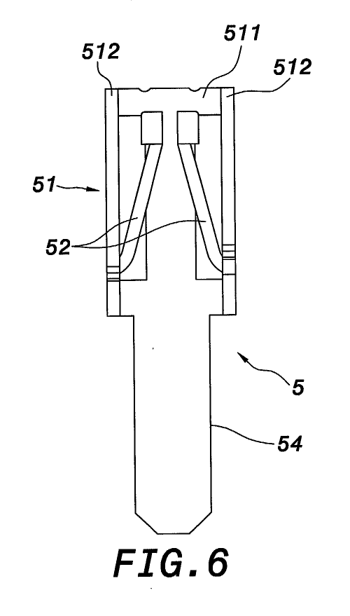

As shown in FIG. 4, the two symmetric sidewalls 512 of the installation portion 51 of the terminal 5 are fully cut and the bottom sides thereof are half cut to form cut lines 501 and 502 and a half cut line 503, thereby correspondingly cutting out the elastic contact pieces 52, which are connected at one side, as shown in FIG. 5. Moreover, the two elastic contact pieces 52 are symmetric to each other. The two symmetric elastic contact pieces 52 are bent inwards with the half-cut connected side as the axis, hence forming the terminal 5 shown in FIGS. 5 and 6.

Please refer to FIGS. 5 and 6, the top end of the two symmetric elastic contact pieces 52 of the terminal 5 forms a bell-shaped guide portion for insertion of pin. Especially, the entry and exit directions of the bell must be opposite to those in the prior art. The exit is at the rear side of the terminal facing the rear wall 511, and the entry is at the front side of the terminal facing the unique transversal opening of the installation portion 51.

As shown in FIG. 7A, a single terminal passageway 6 is formed in an insulating main body 600 in an electric connector. The shape of the terminal passageway 6 corresponds to the profile of the installation portion 51 of the terminal 5, and is a very simple frame-shaped or rectangular terminal passageway

As shown in FIG. 7B, after the terminal 5 is inserted into the terminal passageway 6, three walls of the installation portion 51 of the terminal 5 can abut tightly against corresponding inner walls of the terminal passageway 6, and intervention portions 53 at the front side of the two symmetric sidewalls 512 can be intervened by the corresponding inner walls of the terminal passageway 6. The installation portion 51 of the terminal 5 can thus be stably inserted into the terminal passageway 6. The two sidewalls 512 are horizontally symmetric in accordance with the apprised inner walls so that the two elastic contact pieces 52 can also be symmetric to each other. In the figure, the pin 7 of an electronic product (not shown) has already been inserted at the entry of the bell.

As shown in FIG. 7C, the electronic product is moved to push the pin 7 toward the exit direction of the bell (or opposite to the direction of the unique transversal opening of the installation portion 51, or the direction of the rear wall 511) so that the pin 7 can elasticly contact the two symmetric elastic contact pieces 52 simultaneously, thereby achieving electric contact of two points.

As shown in FIG. 7D, when the pin 7 is pushed to the end, the pin 7 can further contact the rear wall 511, thereby achieving electric contact of three points.

Accordingly, the electric connector of the present invention has the following functions.

1. The connected side of the two symmetric elastic contact pieces 52 is the elasticity source position. The bell portion at the upper end of the two symmetric elastic contact pieces 52 is the elastic contact position. As shown in FIG. 4, the elasticity source position is in alignment with the elastic contact position. Therefore, the elasticity of the elasticity source position can be directly extended upwards, and the bell portion of the two elastic contact pieces 52 can have stable and uniform elasticity.

2. Because the two symmetric elastic contact pieces 52 are directly formed by cutting the two symmetric sidewalls 512 with one side connected, and the installation portion 51 of the terminal 5 abuts against the inner walls of the terminal passageway 6, the deviation degree of the two symmetric elastic contact pieces 52 is very small.

3. The symmetric elastic contact pieces 52 are formed on the corresponding sidewalls 512 with one side connected. The sidewalls 512 abut against the corresponding inner walls of the terminal passageway 6. Therefore, the deviation degree of the two elastic contact pieces 52 is very small so that their elastic contact with the pin 7 is very stable and uniform. Moreover, the exit of the bell at the upper end of the two elastic contact pieces 52 is exactly the rear wall 511 so that better and stable electric contact of 2˜3 points can be achieved between the pin 7 of the electronic product and the electric connector of the present invention.

4. The installation portion 51 itself of the terminal 5 is a rectangular frame-shaped structure viewed from top. Therefore, if the shape of the terminal passageway 6 corresponds to the profile of the installation portion 51, the installation portion 51 can be stably positioned in the terminal passageway 6 immediately after the terminal 5 is inserted into the terminal passageway 6. Through simplification of the shape of terminal, the matched terminal passageway can also be simplified to be a very simple rectangular frame shape. Therefore, the mold can be formed by high-accuracy high-efficiency polishing processing. It is not necessary to use the low-efficiency electric discharge processing way. The precision of each component and the assembly quality can be enhanced.

5. Because the outside of the elastic contact pieces 52 are triply protected by the sidewalls 512 and the rear wall 511, the elastic contact pieces 52 can be well protected during the manufacturing process (e.g., electroplating processing or assembly processing), hence increasing the yield and assuring the quality.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An improved electric connector structure comprising
a insulating main body having a plurality of terminal passageways; and
a plurality of terminals having elastic contact pieces, said terminal being composed of an installation portion having opposite walls and a pin portion extended below said installation portion, the two opposite walls of said installation portion being cut to form said elastic contact pieces, which are connected at one side and bent in between the two opposite walls of said installation portion;
wherein, the terminals are respectively disposed in the terminal passageways of the insulating main body.

2. An improved electric connector structure as claimed in claim 1, wherein said two symmetric elastic contact pieces of said installation portion of said terminal have a guide bell for insertion of a pin, and an entry of said bell corresponds to an unique transversal opening of said installation portion.

3. An improved electric connector structure as claimed in claim 2, wherein a pin of an electronic product is pushed toward a rear side of said terminal or opposite to the direction of the unique transversal opening of said installation portion.

4. An improved electric connector structure as claimed in claim 3, wherein an exit of said bell of said two symmetric elastic contact pieces of said terminal corresponds to a connection portion between the two opposite walls of said installation portion, and a pin of the electronic product contacts said two elastic contact pieces and said connection portion.

5. An improved electric connector structure as claimed in claim 1, wherein the cross section of said installation portion of said terminal is a vertically bent U shape composed of the two symmetric sidewalls and a rear wall, and said two elastic contact pieces are formed of the two sidewalls.

6. An improved electric connector structure as claimed in claim 5, wherein the shape of said terminal passageway corresponded to the profile of said installation portion is a frame-shaped and said installation portion abuts tightly against inner walls of said terminal passageway.

7. An improved electric connector structure as claimed in claim 1, wherein said two symmetric elastic contact pieces are respectively further bent inwards with the half-cut connected side as the axis.

8. An improved electric connector structure as claimed in claim 1, wherein the connected side of said two symmetric elastic contact pieces of said terminal are respectively at a bottom side of said elastic contact pieces.

9. An improved electric connector structure as claimed in claim 1, wherein the shape of said terminal passageway corresponds to the profile of said installation portion.
